(19) United States
(12) Patent Application Publication
(10) Pub. No.: US 2026/0255404 A1
(43) Pub. Date: Aug. 27, 2026

(54) RANDOM ACCESS CHANNEL ENHANCEMENTS FOR SUPPORTING TWO TIMING ADVANCES CONFIGURED WITH RESPECT TO A SINGLE SERVING CELL WITH USER EQUIPMENT TRIGGERED RANDOM ACCESS CHANNELS

(71) Applicant: APPLE INC., Cupertino, CA (US)

(72) Inventors: Haitong Sun, Cupertino, CA (US); Dawei Zhang, Saratoga, CA (US); Wei Zeng, San Diego, CA (US); Hong He, San Jose, CA (US); Chunxuan Ye, San Diego, CA (US); Jie Cui, San Jose, CA (US)

(21) Appl. No.: 19/160,295

(22) PCT Filed: Mar. 22, 2024
(86) PCT No.: PCT/US2024/021055

§ 371 Date: Aug. 27, 2025

Related U.S. Application Data
(60) Provisional application No. 63/492,936, filed on Mar. 29, 2023.

(51) Int. Cl. H04W 74/0838; H04B 7/06

(52) U.S. Cl. CPC H04W 74/0838; H04B 7/0626

(57) ABSTRACT

Random access channel (RACH) enhancements for supporting two timing advances (TAs) configured with respect to a single serving cell are discussed herein. There may be two TAs configured/in operation with respect to a same (single) serving cell used by a user equipment (UE). The two TAs may be understood at the UE in terms of two timing advance groups (TAGs). Some proposals herein relate to the use of RACH operations triggered by the network through the use of a PDCCH order sent to a UE. Some proposals herein relate to the use of RACH operations triggered at/by the UE. In various embodiments, inter-cell and/or intra-cell contexts corresponding to these two TA cases may be applicable.

### TECHNICAL FIELD

This application relates generally to wireless communication systems, including wireless communication systems supporting two timing advances configured with respect to a same serving cell.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range (FR) 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a first diagram showing physical channel aspects for transmissions between a UE, a first TRP, and a second TRP and a second diagram showing corresponding UL timing aspects for the same, according to embodiments herein.

FIG. 2 illustrates an IE that includes an index to be used to identify a sequence to be used to generate a preamble for a CFRA.

FIG. 3 illustrates a method of a UE, according to embodiments herein.

FIG. 4 illustrates a method of a RAN, according to embodiments herein.

FIG. 5 illustrates a method of a UE, according to embodiments herein.

FIG. 6 illustrates a method of a RAN, according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Improvements with respect to multiple transmission reception point (TRP) (mTRP) use at a network and/or multiple antenna panel use at a UE may improve the overall utility of a wireless communication system.

It has been recognized that in various wireless communication systems operating according to a 3GPP specification, physical downlink shared channel (PDSCH)/physical downlink control channel (PDCCH)/physical uplink control channel (PUCCH)/physical uplink shared channel (PUSCH) uses presume that different TRPs are perceived as synchronized by the UE, in that a maximum receive timing difference (MRTD) for channels that using different TRPs with respect to the UE is less than a cyclic prefix (CP) used at the UE. However, it has been determined that, in practice, it is possible that from the UE perspective, the MRTD between different TRPs may be more than a CP used by the UE, ultimately leading to perceived interference with respect to the TRPs for communications with the TRPs. One such case may occur when a timing synchronization error between two TRPs is large, and the distance differences between the antenna panels and their corresponding TRPs are large.

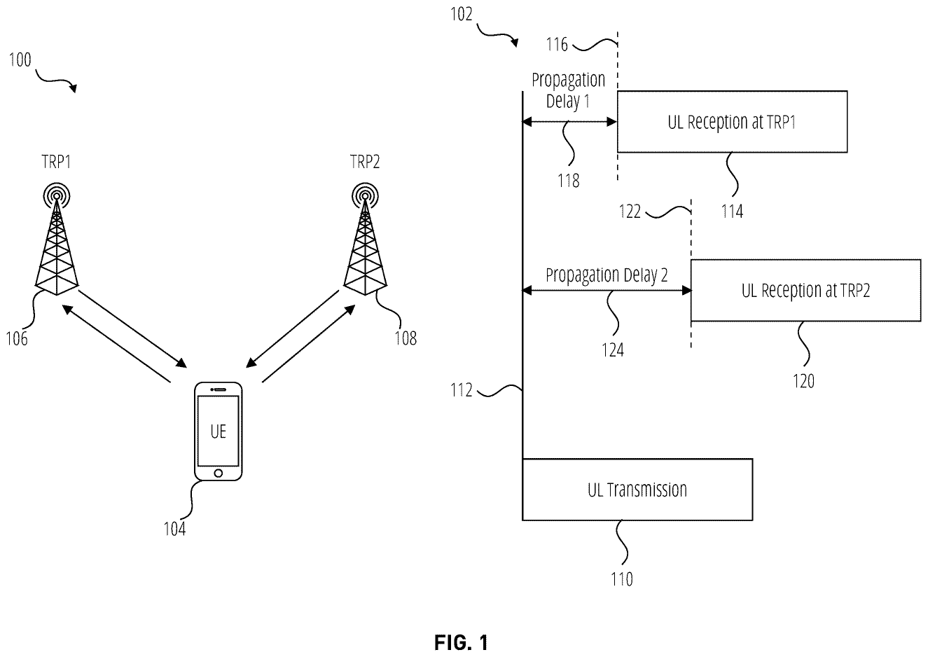

FIG. 1 illustrates a first diagram 100 showing physical channel aspects for transmissions between a UE 104, a first TRP 106 (labelled “TRP1” in FIG. 1) and a second TRP 108 (labelled “TRP2” in FIG. 1) and a second diagram 102 showing corresponding uplink (UL) timing aspects for the same, according to embodiments herein. As illustrated, the UE 104 may communicate with each of the first TRP 106 and the second TRP 108 in UL and/or downlink (DL) directions.

With respect to UL, the UE may perform a UL transmission 110 at a transmission time 112. Then, due to differences in distance between the UE 104 and each of the first TRP 106 and the second TRP 108, the first UL reception 114 may occur at the first TRP 106 at a first UL reception time 116 corresponding to a first propagation delay 118 while the second UL reception 120 may occur at the second TRP 108 at a second UL reception 120 corresponding to a second propagation delay 124. Further, a timing synchronization error/inconsistency at the first TRP 106 with respect to the second TRP 108 (or vice-versa) may increase the effective difference between first UL reception time 116 and the second UL reception 120. Based on, for example, a compounding of the propagation delay differences for each of the first TRP 106 and the second TRP 108 and synchronization errors between the first TRP 106 and the second TRP 108, the total effective MRTD between the first TRP 106 and the second TRP 108 may exceed the CP used by the UE.

It has been accordingly determined that it is beneficial to specify multiple timing advances (TAs) in the case of UL multiple downlink control information (DCI) for mTRP operation. For example, it may be beneficial to enable the use of two TAs for UL multi-DCI for mTRP cases (and optionally along with, e.g., power control for UL single DCI for mTRP operation where a unified transmission configuration indicator (TCI) framework extension is assumed).

It has also accordingly been determined that it is beneficial to support the configuration and use of two TAs with respect to two timing advance groups (TAGs) that are configured with respect to a same serving cell used at the UE. For example, for multi-DCI based mTRP operations using two TAs, it may be beneficial to support configuring two TAGs with respect to a (single) serving cell configured at the UE.

In an inter-cell context, this may mean that the UE is aware of two independent TAs that it should use for two different cells, one of which is the serving cell and the other of which is a non-serving cell). Accordingly, embodiments herein contemplate the use of the two TAGs in an inter-cell mTRP context, where each TAG uses an independent TA. It may be understood in such a context that a first cell of the network that is accessed by the UE via a first TRP is a member of a first TAG that uses the first TA (and accordingly transmissions on the first cell by the UE use the first TA), and that a second cell of the network that is accessed by the UE via a second TRP is a member of a second TAG that uses the second TA (and accordingly transmissions on the second cell by the UE use the second TA). Further, as noted herein, cases where the TAs are for two different cells, one of which is the serving cell and the other of which is a non-serving cell, are contemplated. Accordingly, embodiments herein may identify the two cells in question as being one of a “serving cell” or one of one or more “non-serving cells.” Finally, it will be understood that each of the two cells operates as a “neighbor cell” to the other in these contexts.

In an inter-cell context, the UE may be aware of two independent TAs that it should use on the same (single) cell, where the selection of which TA to use may be based on context. Accordingly, embodiments herein also contemplate the use of the two TAGs in an intra-cell mTRP context, where each TAG uses an independent TA. It may be understood in such a context that a UE accesses the cell on a first TRP according to a first TAG that uses the first TA (and accordingly transmissions on the cell by the UE to the first TRP use the first TA), and that the UE accesses the cell on a second TRP according to a second TAG that uses the second TA (and accordingly transmissions on the cell by the UE to the second TRP use the second TA).

Proposals described herein relate particular solutions for/improvements to random access channel (RACH) enhancements (for RACH operations between the UE and the network) in contexts where there are two TAs configured/in operation with respect to a same (single) serving cell used by the UE. Some proposals herein relate to the use of RACH operations triggered by the network through the use of a PDCCH order sent to a UE. Some proposals herein relate to the use of RACH operations triggered at the UE (e.g., rather than by a network-provided PDCCH order).

### Embodiments With Respect to RACH Operations Triggered by PDCCH Orders

In some cases, a DCI sent by the network to a UE may include a PDCCH order that triggers the UE to initiate a RACH operation with the network. For example, it may be that the UE is in an UL out of sync (OOS) state, and there is mobile terminated (MT) DL data for the UE at the network. In such circumstances, before the network schedules the DL data, the network may first signal a PDCCH order to the UE. The PDCCH order triggers the UE to perform a first physical random access channel (PRACH) transmission of a RACH operation. As a result of the RACH operation so triggered, the network is able to update the UE with a current TA that the UE should use to communicate with the network.

In some wireless communication systems, a DCI containing a PDCCH order may be of format 1_0, have cyclic redundancy check (CRC) data that is scrambled by an applicable cell-radio network temporary identifier (C-RNTI), and include a frequency domain resource assignment (FDRA) field having ones in every bit. Further, it may be that in some wireless communication systems, a DCI containing a PDCCH order includes one or more of:
a random access preamble index that is set according to an ra-PreambleIndex information element (IE) (the field used for this value may be, e.g., six bits);
a UL/supplementary uplink (SUL) indicator that indicates a UL carrier in the cell on which to transmit the PRACH transmission in the case that the bits of the random access preamble index are not all zeros and if the UE is configured with a supplementaryUplink data member in a ServingCellConfig IE for the applicable cell (the field used for this value may be, e.g., one bit);
a synchronization signal (SS)/physical broadcast channel (PBCH) index that indicates the SS/PBCH that is used to determine a RACH occasion (RO) for the PRACH transmission in the case that the bits of the random access preamble index are not all zeros (the field used for this value may be, e.g., 6 bits);
a PRACH mask index that indicates the RO associated with the SS/PBCH index for the PRACH transmission in the case that the bits of the random access preamble index are not all zeros (the field used for this value may be, e.g., 4 bits); and
Reserved bits, where there may be, for example, 12 reserved bits in a case of operation in a cell with shared spectrum channel access in FR1 or when the DCI format is monitored in a common search space for operation in a cell in FR2-2; otherwise there may be 10 such reserved bits.

In some embodiments, in an inter-cell mTRP context using two TAGs with independent TAs, a PDCCH order received at the UE on a first cell may be used to trigger a PRACH transmission by the UE towards the neighbor cell. Such a PDCCH order may include a PRACH target cell information field that provides the UE with PRACH target cell information that identifies the neighbor cell in question. It may be assumed that (the network may ensure that) the neighbor cell transmits/carries the synchronization signal block (SSB) that is identified by the SS/PBCH index of the DCI, such that an appropriate RO for a PRACH transmission corresponding to the PDCCH order may be identified on the neighbor cell with respect to that SSB. Such a PDCCH order may be carried by, for example, a DCI of format 1_0 as understood with respect to definitions for some wireless communication systems.

Such PRACH target cell information may be presented in differing ways and according to differing bit widths of a corresponding PRACH target cell information field having the PRACH target cell information. In a first option, a PRACH target cell information field is 1 bit. In such cases, the single bit value representing the PRACH target cell information may correspond to one of either the serving cell as configured in an active TCI state of the UE or a non-serving cell as configured in the active TCI state of the UE. Accordingly, the UE may apply the bit value with the active TCI state to identify/select one of the serving cell and the non-serving cell as the PRACH target cell for the PDCCH order.

In a second option, the PRACH target cell information field is ceil(log₂(N)) bits, where N is a number of one or more active non-serving cells at the UE. The non-serving cells may be understood at the UE corresponding to a set of physical cell identities (PCIs) for those non-serving cells known to the UE (for example, as one or more PCIs in a number of SSB-MTC-AdditionalPCI-r17 IEs configured in an additionalPCI-TOAddModList-17 IE at the UE, in some wireless communication systems). In such cases, the value represented by the PRACH target cell information may be an index value that the UE applies to the set of PCIs for the one or more active non-serving cells to select a PCI of the set of PCIs. This enables the UE to identify/select the non-serving cell corresponding to the PCI as the PRACH target cell of the PDCCH order.

In a third option, the PRACH target cell information field is ceil(log₂(Nₘₐₓ)) bits, where Nₘₐₓ is a maximum number of configurable non-serving cells for the UE. This maximum may be understood in terms of a maximum on a number of a set of PCIs for non-serving cells that may be configured at the UE (for example, as a maximum number of one or more PCIs represented by a number of SSB-MTC-AdditionalPCI-r17 IEs that may be configured in an additionalPCI-TOAddModList-17 IE at the UE, in some wireless communication systems). In such cases, the value represented by the PRACH target cell information may be an index value that the UE applies to a set of PCIs corresponding to the maximum number of one or more active non-serving cells to select a PCI. The set of PCIs may be the set of PCIs representing an (optional) fully populated configuration corresponding to the maximum number of active non-serving cells possible. Note that as the network may not necessarily actually configure this maximum number of non-serving cells to the UE at a given time, the network may accordingly ensure that the index value provided in the PRACH target cell information corresponds to a PCI that of a non-serving cell that is actually presently active. With knowledge of the PCI, the UE is accordingly enabled to identify/select the non-serving cell corresponding to the PCI as the PRACH target cell of the PDCCH order.

Note that in some cases, a maximum number of one or more non-serving cells configurable at the UE is seven. Accordingly, in such cases, the PRACH target cell information field is ceil(log₂(7))=3 bits.

In a fourth option, a PRACH target cell information field may be of a number of bits that is sufficient to directly identify a PCI. In such cases, it may be that the PRACH target cell information accordingly identifies the PCI of the intended PRACH target cell of the PDCCH order. Then, with knowledge of the PCI, the UE is accordingly enabled to identify/select the cell corresponding to the PCI as the PRACH target cell of the PDCCH order. Note that in these cases, the PRACH target cell (the cell corresponding to the indicated PCI) may be either the serving cell or one of one or more non-serving cells.

Note that in some wireless communication networks, a PCI can be represented by 10 bits. Accordingly, in such networks, it may be that the PRACH target cell information field may be 10 bits long. Accordingly, upon receiving the PCI as PRACH target cell information in this field, the UE is enabled to identify/select the cell corresponding to the PCI as the PRACH target cell of the PDCCH order.

In some embodiments, in an inter-cell mTRP context using two TAGs with independent TAs, when a PRACH target cell information field having PRACH target cell information is introduced in the DCI of the PDCCH order to support triggering a PRACH transmission towards a neighbor cell (e.g., as described herein), if the bit width for the PRACH target information field is X bits, the number of reserved bits that may be present in the DCI according to some wireless communication systems is reduced by X bits. For example, in some wireless communication networks, this may mean that the DCI carries 12−X reserved bits for shared spectrum in FR1 or common search space for FR2-2 (e.g., above 52.6 GHz), and 10−X reserved bits otherwise.

In some embodiments, in an inter-cell mTRP context using two TAGs with independent TAs, when a PRACH target cell information field having PRACH target cell information is introduced in the DCI of the PDCCH order to support triggering a PRACH transmission towards a neighbor cell (e.g., as described herein), it may be that one pre-configured value may be used to indicate the serving cell. For example, in a first option, a value of all zeros in binary in the PRACH target cell information field may be used to indicate the serving cell. As another example, in a second option, a value of all ones in binary in the PRACH target cell information field may be used to indicate the serving cell. Upon receiving the pre-configured value, the UE accordingly understands that it is to select the serving cell as the PRACH target cell.

In some embodiments, in an inter-cell mTRP context using two TAGs with independent TAs, it may be that a UE can provide the network with capability information indicating a maximum number of non-serving cells that it can support as identifiable PRACH target cells with respect to a PDCCH order that triggers the PRACH transmission towards a neighbor cell in the PDCCH order. This number may be understood by the network as a maximum number of non-serving cells supported at the UE as identifiable PRACH target cells in addition to the serving cell (which may also be identified as a PRACH target cell in at least some cases, for example, as described herein). Note that this capability (for a maximum number of non-serving cells that a UE can support as identifiable PRACH target cells with respect to a PDCCH order that triggers the PRACH transmission towards a neighbor cell in the PDCCH order) may also be used to determine/may control the bitwidth of PRACH target cell information field.

In some embodiments, in an inter-cell mTRP context using two TAGs with independent TAs, various power control aspects may be implemented. For example, when an SSB associated with a PRACH transmission corresponds to the serving cell, or when an SSB that is the quasi-colocation (QCL) source of a channel state information reference signal (CSI-RS) associated with the PRACH transmission corresponds to the serving cell, the UE may refer to an SSB power level for that SSB in an ss-PBCH-BlockPower IE configured in one of a ServingCellConfigCommon IE, a ServingCellConfigCommonSIB IE, and/or an SSB-Configuration-r16 IE to determine the SSB power level of that SSB. The UE may then perform a corresponding power control calculation for a PRACH transmission on the serving cell that is based on the SSB power level of the SSB (e.g., that may use a path loss value for the SSB determined with respect to the power level of the SSB).

Further, when an SSB associated with a PRACH transmission corresponds to a non-serving cell, or when an SSB that is the QCL source of a CSI-RS associated with the PRACH transmission corresponds to a non-serving cell, the UE may refer to an SSB power level in an ss-PBCH-BlockPower IE configured in an SSB-MTC-AdditionalPCI-r17 IE for the non-serving cell indicated to the UE by the network to determine the SSB power level of the SSB. The UE may then perform a corresponding power control calculation for a PRACH transmission on the non-serving cell that is based on the SSB power level of the SSB (e.g., that may use a path loss value for the SSB determined with respect to the power level of the SSB).

### Embodiments With Respect to UE-Triggered RACH Operations

In some embodiments, in an inter-cell mTRP or in an intra-cell mTRP context using two TAGs with independent TAs, for each TAG, the network may configure a list of SSBs and/or CSI-RSs for each TAG by radio resource control (RRC) signaling. A CSI-RS may be identified in the RRC signaling by an NZP-CSI-RS-ResourceId IE. An SSB may be identified in the RRC signaling by an SSB-Index IE, and additionally by a PCI.

Each SSB/CSI-RS associated with a same TAG may be assumed to provide a same DL reference timing for UL operation according to the associated TAG. Note that in cases where a provided SSB/CSI-RS is not explicitly associated with a TAG in the RRC signaling, that SSB/CSI-RS may be assumed to be associated with a first TAG (e.g., with respect to an ordering of the two TAG as they appear in the RRC signaling).

In some embodiments, in an inter-cell mTRP or in an intra-cell mTRP context using two TAGs with independent TAs, for each TAG, when the network configures a list of SSBs and/or CSI-RSs for each TAG using RRC signaling (e.g., as described herein), any SSB associated with a same PCI may be understood to be configured in the same TAG. Further, taking a case where a QCL source of one or more CSI-RSs can be one or more SSBs, it may be that any CSI-RSs that are quasi-colocated (QCL'd) to an SSB associated with the same PCI may be understood to be configured in the same TAG.

In embodiments using a four-step RACH operation for contention based random access (CBRA) in an inter-cell multi-TRP context using two TAGs with independent TAs, it may be that a number of SSBs per RO for a non-serving cell and a number of contention-based preambles per SSB for the non-serving cell are provided to the UE for a non-serving cell as part of an inter-cell mTRP operation (e.g., in an ssb-perRACH-OccasionAndCB-PreamblesPerSSB IE for the non-serving cell in a RACH-ConfigCommon IE). Thus, it may be understood that in some embodiments, a first information element indicating, for a CBRA, a first number of SSBs per RO for the serving cell and a first number of contention-based preambles per SSB for the serving cell (e.g., a first ssb-perRACH-OccasionAndCB-PreamblesPerSSB IE for the serving cell in a RACH-ConfigCommon IE) and a second information element indicating, for the CBRA, a second number of SSBs per RO for the non-serving cell and a second number of contention-based preambles per SSB for the non-serving cell (e.g., a second ssb-perRACH-OccasionAndCB-PreamblesPerSSB IE for the non-serving cell in the RACH-ConfigCommon IE) may be provided to the UE. The first number of SSBs per RO for the serving cell and the first number of contention-based preambles per SSB for the serving cell may accordingly be used by the UE to identify a RO for the serving cell in the multi-TRP context, while the second number of SSBs per RO for the non-serving cell and the second number of contention-based preambles per SSB for the non-serving cell may accordingly be used by the UE to identify an RO for the non-serving cell in the multi-TRP context.

In cases where the second number of SSBs per RO for the non-serving cell and a second number of contention-based preambles per SSB for the non-serving cell, a PCI may also be included in the corresponding to this configuration (e.g., in the second ssb-perRACH-OccasionAndCB-PreamblesPerSSB IE for the non-serving cell), thereby enabling the UE to identify the non-serving cell.

In embodiments using a four-step RACH operation for CBRA in an inter-cell multi-TRP context using two TAGs with independent TAs, it may be that an index for a sequence to be used to generate a preamble for a RACH operation corresponding to a reference signal of a reference signal list for the non-serving cell is provided to the UE for a non-serving cell as part of an inter-cell multi-TRP operation (e.g., in a prach-RootSequenceIndex IE for the non-serving cell in a RACH-ConfigCommon IE). Thus, it may be understood that in some embodiments, a first information element indicating, for a CBRA, a first sequence to be used to generate a first preamble for a first RACH operation corresponding to a first reference signal of a first reference signal list for the serving cell (e.g., a first prach-RootSequenceIndex IE for the serving cell in a RACH-ConfigCommon IE) and a second information element indicating, for a CBRA, a second sequence to be used to generate a second preamble for a second RACH operation corresponding to a second reference signal of a second reference signal list for the serving cell (e.g., in second prach-RootSequenceIndex IE for the non-serving cell in the RACH-ConfigCommon IE) may be provided to the UE. The first sequence may accordingly be used by the UE to generate a preamble for the first RACH operation on the serving cell, while the second sequence may accordingly be used by the UE to generate a preamble for the second RACH operation on the non-serving cell.

In embodiments using either a two-step RACH operation or a four-step RACH operation for contention free random access (CFRA) in an inter-cell multi-TRP context using two TAGs with independent TAs, the network may provide the UE with an IE (e.g., a CRFA-SSB-Resource IE) that includes an index for a sequence to be used to generate a preamble for the CFRA. In some cases, if the network wants the index to be used to identify a sequence to use to generate such a preamble for the non-serving cell, the network may also include a PCI of the non-serving cell in the IE (e.g., in an additionalPCI IE). In cases where the index is to be used to identify a sequence used to generate such a preamble for the serving cell, the network may omit the PCI, and the UE may assume based on this omission that the index is to be used to generate a preamble on the serving cell.

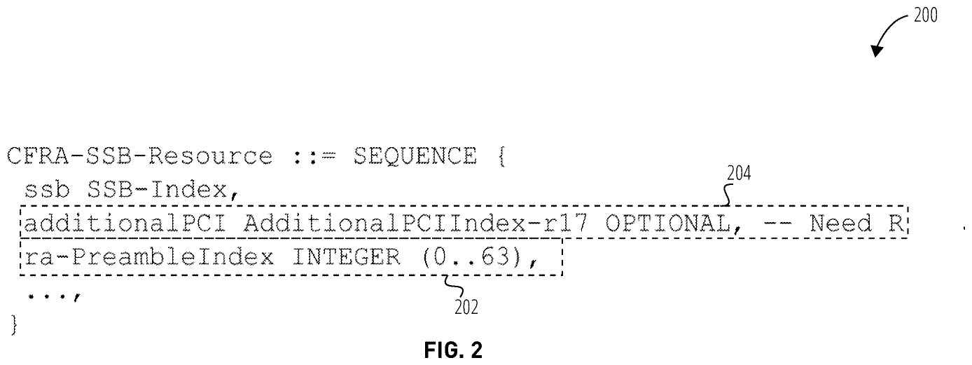

FIG. 2 illustrates an IE 200 that includes an index 202 (e.g., as the illustrated ra-PreambleIndex IE) to be used to identify a sequence to be used to generate a preamble for a CFRA. Further, as illustrated, the IE 200 also includes a PCI 204 (e.g., as the illustrated additionalPCI IE) to be used identify a PCI of a cell (e.g., of a non-serving cell) for which the index 202 is to be used.

In embodiments using a four-step RACH operation for CFRA in an inter-cell multi-TRP context using two TAGs with independent TAs, it may be that a number of SSBs per RO for a non-serving cell is provided to the UE for a non-serving cell as part of an inter-cell multi-TRP operation (e.g., in an ssb-perRACH-Occasion IE for the non-serving cell in a RACH-ConfigDedicated IE). Thus, it may be understood that in some embodiments, a first information element indicating, for a CFRA, a first number of SSBs per RO for the serving cell (e.g., in a first ssb-perRACH-Occasion IE for the non-serving cell in a RACH-ConfigDedicated IE) and a second information element indicating, for the CFRA, a second number of SSBs per RO for the non-serving cell (e.g., in a second ssb-perRACH-Occasion IE for the non-serving cell in the RACH-ConfigDedicated IE) may be provided to the UE. The first number of SSBs per RO for the serving cell may accordingly be used by the UE to identify a RO for the serving cell in the multi-TRP context, while the second number of SSBs per RO for the non-serving cell may accordingly be used by the UE to identify an RO for the non-serving cell in the multi-TRP context.

In embodiments using a two-step RACH operation for CBRA in an inter-cell multi-TRP context using two TAGs with independent TAs, an independent configuration for each cell (e.g., a first independent configuration for the serving cell and a second independent configuration for the non-serving cell) may be provided (e.g., in a RACH-ConfigCommonTwoStepRA IE). These independent configurations may include, for RO configuration, one or more of the following: an information element indicating, for CBRA, a number of synchronization SSBs per RO for a two-step RACH operation and a number of contention-based preambles per SSB for the two-step RACH operation for the corresponding cell (e.g., a msgA-SSB-PerRACH-OccasionAndCB-PreamblesPerSSB-r16 IE for the corresponding cell); an information element indicating, for CBRA, a number of contention-based preambles per SSB for a two-step RACH operation for the corresponding cell (e.g., a msgA-CB-PreamblesPerSSB-PerSharedRO-r16 IE for the corresponding cell); and/or an information element indicating, for CBRA, a subset of four-step RACH operation ROs that are usable in the two-step RACH operation for the corresponding cell (e.g., a msgA-SSB-SharedRO-MaskIndex-r16 IE for the corresponding cell).

Further, each of the independent configurations for the cells may include, for RACH sequence configuration, an IE indicating, for CBRA, an index for a sequence to be used to generate a preamble for a two-step RACH operation corresponding to a reference signal of a reference signal list for the corresponding cell (e.g., a msgA-PRACH-RootSequenceIndex-r16 IE for the corresponding cell).

In embodiments using a two-step RACH operation for CFRA in an inter-cell multi-TRP context using two TAGs with independent TAs, it may be that a number of SSBs per RO for a non-serving cell is provided to the UE for a non-serving cell as part of an inter-cell multi-TRP operation (e.g., in an ssb-PerRACH-OccasionTwoStepRA-r16 IE for the non-serving cell in a CFRA-TwoStep-r16 IE). Thus, it may be understood that in some embodiments, a first information element indicating, for a CFRA, a first number of SSBs per RO for the serving cell (e.g., a first ssb-PerRACH-OccasionTwoStepRA-r16 for the serving cell IE in a CFRA-TwoStep-r16 IE) and a second information element indicating, for the CFRA, a second number of SSBs per RO for the non-serving cell (e.g., in a second ssb-PerRACH-OccasionTwoStepRA-r16 for the non-serving cell in the CFRA-TwoStep-r16 IE) may be provided to the UE. The first number of SSBs per RO for the serving cell may accordingly be used by the UE to identify a RO for the serving cell with respect to the applicable SSB in the multi-TRP context, while the second number of SSBs per RO for the non-serving cell may accordingly be used by the UE to identify an RO for the non-serving cell with respect to the applicable SSB in the multi-TRP context.

In some embodiments, in an inter-cell mTRP context using two TAGs with independent TAs, various power control aspects may be implemented. For example, when an SSB associated with a PRACH transmission corresponds to the serving cell, or when an SSB that is the QCL source of a CSI-RS associated with the PRACH transmission corresponds to the serving cell, the UE may refer to an SSB power level in an ss-PBCH-BlockPower IE for that SSB configured in one of a ServingCellConfigCommon IE, a ServingCellConfigCommonSIB IE, and/or an SSB-Configuration-r16 IE to determine the power level of that SSB. The UE may then perform a corresponding power control calculation for a PRACH transmission on the serving cell that is based on the SSB power level of the SSB (e.g., that may use a path loss value for the SSB determined with respect to the power level of the SSB).

Further, when an SSB associated with a PRACH transmission corresponds to a non-serving cell, or when an SSB that is the QCL source of a CSI-RS that is associated with the PRACH transmission corresponds to a non-serving cell, the UE may refer to an SSB power level in an ss-PBCH-BlockPower IE configured in an SSB-MTC-AdditionalPCI-r17 IE for the non-serving cell indicated to the UE by the network to determine the SSB power level of the SSB. The UE may then perform a corresponding power control calculation for a PRACH transmission on the non-serving cell that is based on the SSB power level of the SSB (e.g., that may use a path loss value for the SSB determined with respect to the power level of the SSB).

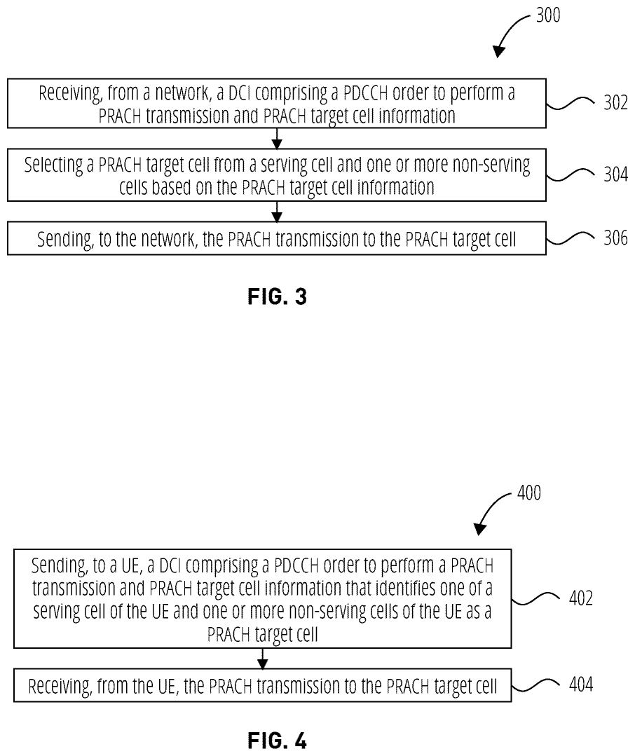

FIG. 3 illustrates a method 300 of a UE, according to embodiments herein. The method 300 includes receiving 302, from a network, a DCI comprising a PDCCH order to perform a PRACH transmission and PRACH target cell information. The method 300 further includes selecting 304 a PRACH target cell from a serving cell and one or more non-serving cells based on the PRACH target cell information. The method 300 further includes sending 306, to the network, the PRACH transmission to the PRACH target cell.

In some embodiments of the method 300, the PRACH target cell information comprises a bit value, each of the serving cell and a first non-serving cell of the one or more non-serving cells are configured in an active TCI state of the UE, and the selecting the PRACH target cell based on the PRACH target cell information comprises applying the bit value with the active TCI state to select one of the serving cell and the first non-serving cell as the PRACH target cell.

In some embodiments of the method 300, the PRACH target cell information comprises an index value, the one or more non-serving cells comprises one or more active non-serving cells at the UE, and the selecting the PRACH target cell based on the PRACH target cell information comprises: applying the index value to a set of PCIs for the one or more active non-serving cells to identify a first PCI from the set of PCIs, and identifying a first non-serving cell of the one or more active non-serving cells as the PRACH target cell using the first PCI.

In some embodiments of the method 300, the PRACH target cell information comprises an index value, the one or more non-serving cells comprises one or more configurable non-serving cells for the UE, and the selecting the PRACH target cell based on the PRACH target cell information comprises: applying the index value to a set of one or more PCIs for the one or more configurable non-serving cells to identify a first PCI from the set of PCIs, and identifying a first non-serving cell of the one or more configurable non-serving cells as the PRACH target cell using the first PCI.

In some embodiments of the method 300, the PRACH target cell information comprises a PCI of the PRACH target cell, and the selecting the PRACH target cell based on the PRACH target cell information comprises identifying the PRACH target cell using the PCI.

In some embodiments of the method 300, the PRACH target cell information comprises a pre-configured value corresponding to the serving cell, and the selecting the PRACH target cell based on the PRACH target cell information comprises selecting the serving cell as the PRACH target cell based on the pre-configured value.

In some embodiments, the method 300 further comprises sending, to the network, capability information indicating a maximum number of the one or more non-serving cells that is supported by the UE as identifiable PRACH target cells.

In some embodiments of the method 300, the PRACH target cell comprises a first non-serving cell of the one or more non-serving cells, and further comprising performing a power control calculation for the PRACH transmission based on an SSB power level indicated by the network for the first non-serving cell.

FIG. 4 illustrates a method 400 of a RAN, according to embodiments herein. The method 400 includes sending 402, to a UE, a DCI comprising a PDCCH order to perform a PRACH transmission and PRACH target cell information that identifies one of a serving cell of the UE and one or more non-serving cells of the UE as a PRACH target cell. The method 400 further includes receiving 404, from the UE, the PRACH transmission to the PRACH target cell.

In some embodiments of the method 400, each of the serving cell and a first non-serving cell of the one or more non-serving cells are configured in an active TCI state of the UE, and the PRACH target cell information comprises a bit value indicating one of the serving cell and the first non-serving cell configured in the active TCI state as the PRACH target cell.

In some embodiments of the method 400, the one or more non-serving cells comprises one or more active non-serving cells at the UE, and the PRACH target cell information comprises an index value identifying a first PCI from a set of PCIs for the one or more active non-serving cells, the first PCI corresponding to the PRACH target cell.

In some embodiments of the method 400, the one or more non-serving cells comprises one or more configurable non-serving cells for the UE, and the PRACH target cell information comprises an index value identifying a first PCI from a set of PCIs for the one or more configurable non-serving cells, the first PCI corresponding to the PRACH target cell.

In some embodiments of the method 400, the PRACH target cell information comprises a PCI of the PRACH target cell.

In some embodiments of the method 400, the PRACH target cell information comprises a pre-configured value corresponding to the serving cell.

In some embodiments, the method 400 further comprises receiving, from the UE, capability information indicating a maximum number of the one or more non-serving cells that is supported by the UE as identifiable PRACH target cells.

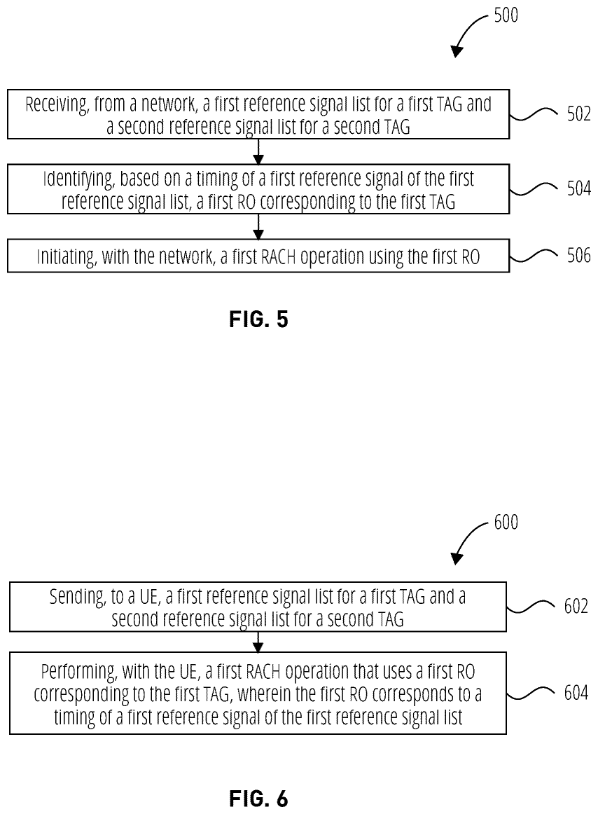

FIG. 5 illustrates a method 500 of a UE, according to embodiments herein. The method 500 includes receiving 502, from a network, a first reference signal list for a first TAG and a second reference signal list for a second TAG. The method 500 further includes identifying 504, based on a timing of a first reference signal of the first reference signal list, a first RO corresponding to the first TAG. The method 500 further includes initiating 506, with the network, a first RACH operation using the first RO.

In some embodiments, the method 500 further comprises identifying, based on a timing of a second reference signal of the second reference signal list, a second RO corresponding to the second TAG, and initiating, with the network, a second RACH operation using the second RO.

In some embodiments of the method 500, the first reference signal list comprises an SSB.

In some embodiments of the method 500, the first reference signal list comprises a CSI-RS.

In some embodiments of the method 500, the first reference signal list comprises one or more first reference signals corresponding to a first PCI of a first cell, and the second reference signal list comprises one or more second reference signals corresponding to a second PCI of a second cell that is different from the first PCI.

In some embodiments of the method 500, one of the first TAG and the second TAG is associated with a serving cell of the UE and another of the first TAG and the second TAG is associated with a non-serving cell of the UE.

In certain such embodiments, the method 500 further comprises receiving, from the network, a first information element indicating, for CBRA, a first number of SSBs per RO for the serving cell and a first number of contention-based preambles per SSB for the serving cell, and a second information element indicating, for the CBRA, a second number of SSBs per RO for the non-serving cell and a second number of contention-based preambles per SSB for the non-serving cell.

In certain such embodiments, the second information element further comprises a PCI for the non-serving cell.

In certain such embodiments, the method 500 further comprises receiving, from the network, a first information element indicating, for CBRA, a first index for a first sequence to be used to generate a first preamble for the first RACH operation corresponding to the first reference signal of the first reference signal list, and a second information element indicating, for the CBRA, a second index for a second sequence to be used to generate a second preamble for a second RACH operation corresponding to a second reference signal of the second reference signal list.

In certain such embodiments, the method 500 further comprises receiving, from the network, an information element indicating: an index for a sequence to be used to generate a preamble for a CFRA on the non-serving cell, and a PCI of the non-serving cell.

In certain such embodiments, the method 500 further comprises receiving, from the network, a first information element indicating, for CFRA, a first number of SSBs per RO for the serving cell, and a second information element indicating, for the CFRA, a second number of SSBs per RO for the non-serving cell.

In certain such embodiments, the method 500 further comprises receiving, from the network, for the non-serving cell, one or more of: a first information element indicating, for CBRA, a first number of SSBs per RO for a two-step RACH operation and a first number of contention-based preambles per SSB for the two-step RACH operation, a second information element indicating, for the CBRA, a second number of contention-based preambles per SSB for the two-step RACH operation, a third information element indicating, for the CBRA, a subset of four-step RACH operation ROs that are usable in the two-step RACH operation, and a fourth information element indicating, for the CBRA, an index for a sequence to be used to generate a preamble for the two-step RACH operation corresponding to a reference signal of one of the first reference signal list and the second reference signal list that is for the non-serving cell.

In certain such embodiments, the method 500 further comprises receiving, from the network, a first information element indicating, for CFRA, a first number of SSBs per RO for the serving cell for a two-step RACH operation, and a second information element indicating, for the CFRA, a second number of SSBs per RO for the non-serving cell for the two-step RACH operation.

In certain such embodiments, the method 500 further comprises performing a power control calculation for a PRACH transmission of one of the first RACH operation and a second RACH operation that is on the non-serving cell based on an SSB power level indicated by the network for the non-serving cell.

FIG. 6 illustrates a method 600 of a RAN, according to embodiments herein. The method 600 includes sending 602, to a UE, a first reference signal list for a first TAG and a second reference signal list for a second TAG. The method 600 further includes performing 604, with the UE, a first RACH operation that uses a first RO corresponding to the first TAG, wherein the first RO corresponds to a timing of a first reference signal of the first reference signal list.

In some embodiments, the method 600 further comprises performing, with the UE, a second RACH operation that uses a second RO corresponding to the second TAG, wherein the second RO corresponds to a timing of a second reference signal of the second reference signal list.

In some embodiments of the method 600, the first reference signal list comprises an SSB.

In some embodiments of the method 600, the first reference signal list comprises a CSI-RS.

In some embodiments of the method 600, the first reference signal list comprises one or more first reference signals corresponding to a first PCI of a first cell, and the second reference signal list comprises one or more second reference signals corresponding to a second PCI of a second cell that is different from the first PCI.

In some embodiments of the method 600, one of the first TAG and the second TAG is associated with a serving cell of the UE and another of the first TAG and the second TAG is associated with a non-serving cell of the UE.

In certain such embodiments, the method 600 further comprises sending, to the UE, a first information element indicating, for CBRA, a first number of SSBs per RO for the serving cell and a first number of contention-based preambles per SSB for the serving cell, and a second information element indicating, for the CBRA, a second number of SSBs per RO for the non-serving cell and a second number of contention-based preambles per SSB for the non-serving cell.

In certain such embodiments, the second information element further comprises a PCI for the non-serving cell.

In certain such embodiments, the method 600 further comprises sending, to the UE, a first information element indicating, for CBRA, a first index for a first sequence to be used to generate a first preamble for the first RACH operation corresponding to the first reference signal of the first reference signal list, and a second information element indicating, for the CBRA, a second index for a second sequence to be used to generate a second preamble for a second RACH operation corresponding to a second reference signal of the second reference signal list.

In certain such embodiments, the method 600 further comprises sending, to the UE, an information element indicating: an index for a sequence to be used to generate a preamble for a CFRA on the non-serving cell, and a PCI of the non-serving cell.

In certain such embodiments, the method 600 further comprises sending, to the UE, a first information element indicating, for CFRA, a first number of SSBs per RO for the serving cell, and a second information element indicating, for the CFRA, a second number of SSBs per RO for the non-serving cell.

In certain such embodiments, the method 600 further comprises sending, to the UE, for the non-serving cell, one or more of: a first information element indicating, for CBRA, a first number of SSBs per RO for a two-step RACH operation and a first number of contention-based preambles per SSB for the two-step RACH operation, a second information element indicating, for the CBRA, a second number of contention-based preambles per SSB for the two-step RACH operation, a third information element indicating, for the CBRA, a subset of four-step RACH operation RACH occasions that are usable in the two-step RACH operation, and a fourth information element indicating, for the CBRA, an index for a sequence to be used to generate a preamble for the two-step RACH operation corresponding to a reference signal of one of the first reference signal list and the second reference signal list that is for the non-serving cell.

In certain such embodiments, the method 600 further comprises sending, to the UE, a first information element indicating, for CFRA, a first number of SSBs per RO for the serving cell for a two-step RACH operation, and a second information element indicating, for the CFRA, a second number of SSBs per RO for the non-serving cell for the two-step RACH operation.

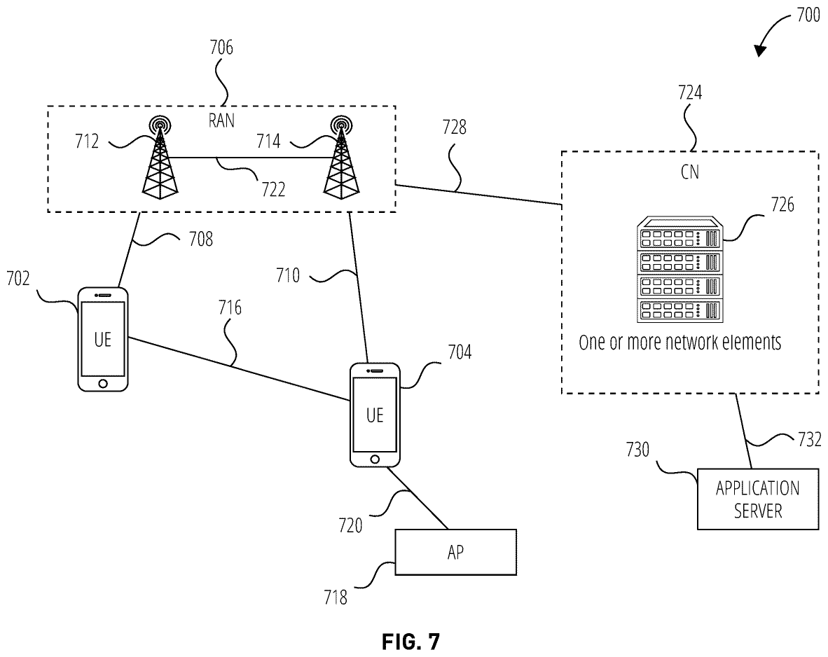

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

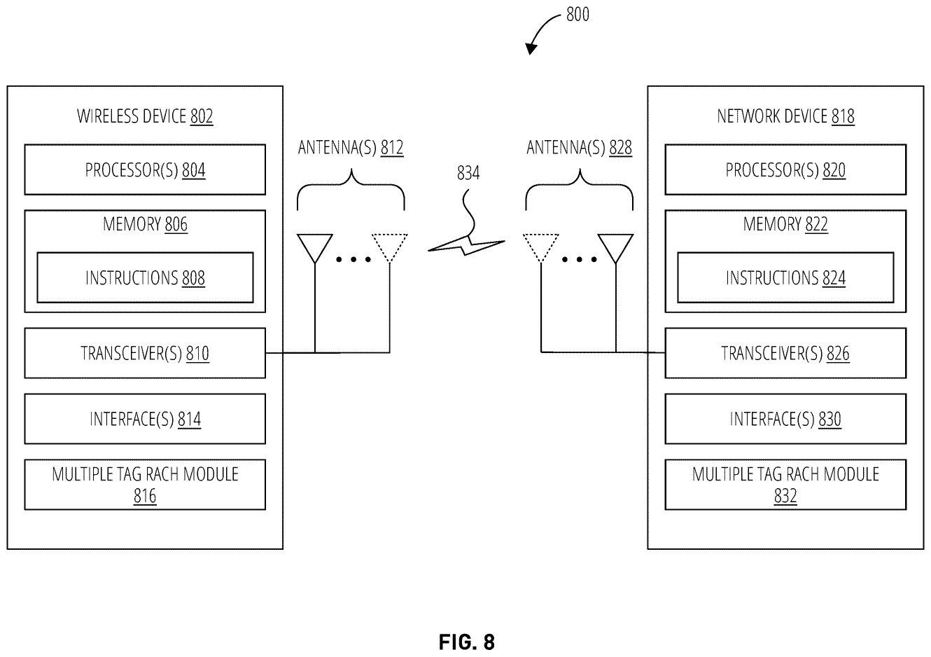

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter circuitry and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a multiple TAG RACH module 816. The multiple TAG RACH module 816 may be implemented via hardware, software, or combinations thereof. For example, the multiple TAG RACH module 816 may be implemented as a processor, circuit, and/or instructions 808 stored in the memory 806 and executed by the processor(s) 804. In some examples, the multiple TAG RACH module 816 may be integrated within the processor(s) 804 and/or the transceiver(s) 810. For example, the multiple TAG RACH module 816 may be implemented by a combination of software components (e.g., executed by a DSP or a general processor) and hardware components (e.g., logic gates and circuitry) within the processor(s) 804 or the transceiver(s) 810.

The multiple TAG RACH module 816 may be used for various aspects of the present disclosure, for example, aspects of FIG. 1 through FIG. 6. The multiple TAG RACH module 816 may be configured to generate RACHs on corresponding ones of multiple TAGs using different TAs as triggered by a PDCCH order and/or as triggered by the UE, in the manner described herein.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter circuitry and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a multiple TAG RACH module 832. The multiple TAG RACH module 832 may be implemented via hardware, software, or combinations thereof. For example, the multiple TAG RACH module 832 may be implemented as a processor, circuit, and/or instructions 824 stored in the memory 822 and executed by the processor(s) 820. In some examples, the multiple TAG RACH module 832 may be integrated within the processor(s) 820 and/or the transceiver(s) 826. For example, the multiple TAG RACH module 832 may be implemented by a combination of software components (e.g., executed by a DSP or a general processor) and hardware components (e.g., logic gates and circuitry) within the processor(s) 820 or the transceiver(s) 826.

The multiple TAG RACH module 832 may be used for various aspects of the present disclosure, for example, aspects of FIG. 1 through FIG. 6. The multiple TAG RACH module 832 may be configured to generate and send PDCCH orders as described herein, and/or to receive RACHs on corresponding ones of multiple TAGs using different TAs as triggered by a PDCCH order and/or as triggered by the UE, in the manner described herein.

Embodiments contemplated herein include an apparatus comprising means to perform one or more elements of any of the method 300 and the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 300 and the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of any of the method 300 and the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 300 and the method 500. This apparatus may be, for example, an apparatus of a UE (such as a wireless device 802 that is a UE, as described herein).

Embodiments contemplated herein include a signal as described in or related to one or more elements of any of the method 300 and the method 500.

Embodiments contemplated herein include a computer program or computer program product comprising instructions, wherein execution of the program by a processor is to cause the processor to carry out one or more elements of any of the method 300 and the method 500. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of any of the method 400 and the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 400 and the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of any of the method 400 and the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 400 and the method 600. This apparatus may be, for example, an apparatus of a base station (such as a network device 818 that is a base station, as described herein).

Embodiments contemplated herein include a signal as described in or related to one or more elements of any of the method 400 and the method 600.

Embodiments contemplated herein include a computer program or computer program product comprising instructions, wherein execution of the program by a processing element is to cause the processing element to carry out one or more elements of any of the method 400 and the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, a first reference signal list for a first timing advance group (TAG) and a second reference signal list for a second TAG;
identifying, based on a timing of a first reference signal of the first reference signal list, a first random access channel (RACH) occasion (RO) corresponding to the first TAG; and
initiating, with the network, a first RACH operation using the first RO.

2. The method of claim 1, further comprising:
identifying, based on a timing of a second reference signal of the second reference signal list, a second RO corresponding to the second TAG; and
initiating, with the network, a second RACH operation using the second RO.

3. The method of claim 1, wherein the first reference signal list comprises a synchronization signal block (SSB).

4. The method of claim 1, wherein the first reference signal list comprises a channel state information reference signal (CSI-RS).

5. The method of claim 1, wherein:
the first reference signal list comprises one or more first reference signals corresponding to a first physical cell identity (PCI) of a first cell; and
the second reference signal list comprises one or more second reference signals corresponding to a second PCI of a second cell that is different from the first PCI.

6. The method of claim 1, wherein one of the first TAG and the second TAG is associated with a serving cell of the UE and another of the first TAG and the second TAG is associated with a non-serving cell of the UE.

7. The method of claim 6, further comprising receiving, from the network:
a first information element indicating, for contention based random access (CBRA), a first number of synchronization signal blocks (SSBs) per RO for the serving cell and a first number of contention-based preambles per SSB for the serving cell; and
a second information element indicating, for the CBRA, a second number of SSBs per RO for the non-serving cell and a second number of contention-based preambles per SSB for the non-serving cell.

8. The method of claim 7, wherein the second information element further comprises a physical cell identity (PCI) for the non-serving cell.

9. The method of claim 6, further comprising receiving, from the network:
a first information element indicating, for contention based random access (CBRA), a first index for a first sequence to be used to generate a first preamble for the first RACH operation corresponding to the first reference signal of the first reference signal list; and
a second information element indicating, for the CBRA, a second index for a second sequence to be used to generate a second preamble for a second RACH operation corresponding to a second reference signal of the second reference signal list.

10. The method of claim 6, further comprising receiving, from the network, an information element indicating:
an index for a sequence to be used to generate a preamble for a contention free random access (CFRA) on the non-serving cell; and
a physical cell identity (PCI) of the non-serving cell.

11. The method of claim 6, further comprising receiving, from the network:
a first information element indicating, for contention free random access (CFRA), a first number of synchronization signal blocks (SSBs) per RO for the serving cell; and
a second information element indicating, for the CFRA, a second number of SSBs per RO for the non-serving cell.

12. The method of claim 6, further comprising receiving, from the network, for the non-serving cell, one or more of:
a first information element indicating, for contention based random access (CBRA), a first number of synchronization signal blocks (SSBs) per RO for a two-step RACH operation and a first number of contention-based preambles per SSB for the two-step RACH operation;
a second information element indicating, for the CBRA, a second number of contention-based preambles per SSB for the two-step RACH operation;
a third information element indicating, for the CBRA, a subset of four-step RACH operation ROs that are usable in the two-step RACH operation; and
a fourth information element indicating, for the CBRA, an index for a sequence to be used to generate a preamble for the two-step RACH operation corresponding to a reference signal of one of the first reference signal list and the second reference signal list that is for the non-serving cell.

13. The method of claim 6, further comprising receiving, from the network:
a first information element indicating, for contention free random access (CFRA), a first number of synchronization signal blocks (SSBs) per RO for the serving cell for a two-step RACH operation; and
a second information element indicating, for the CFRA, a second number of SSBs per RO for the non-serving cell for the two-step RACH operation.

14. The method of claim 6, further comprising performing a power control calculation for a physical random access channel (PRACH) transmission of one of the first RACH operation and a second RACH operation that is on the non-serving cell based on a synchronization signal block (SSB) power level indicated by the network for the non-serving cell.

15. A method of a radio access network (RAN), comprising:
sending, to a user equipment (UE), a first reference signal list for a first timing advance group (TAG) and a second reference signal list for a second TAG; and
performing, with the UE, a first random access channel (RACH) operation that uses a first RACH occasion (RO) corresponding to the first TAG, wherein the first RO corresponds to a timing of a first reference signal of the first reference signal list.

16. The method of claim 15, further comprising performing, with the UE, a second RACH operation that uses a second RO corresponding to the second TAG, wherein the second RO corresponds to a timing of a second reference signal of the second reference signal list.

17. The method of claim 15, wherein the first reference signal list comprises a synchronization signal block (SSB).

18. The method of claim 15, wherein the first reference signal list comprises a channel state information reference signal (CSI-RS).

19. The method of claim 15, wherein:
the first reference signal list comprises one or more first reference signals corresponding to a first physical cell identity (PCI) of a first cell; and
the second reference signal list comprises one or more second reference signals corresponding to a second PCI of a second cell that is different from the first PCI.

20. The method of claim 15, wherein one of the first TAG and the second TAG is associated with a serving cell of the UE and another of the first TAG and the second TAG is associated with a non-serving cell of the UE.

21-30. (canceled)
